(19) United States
(12) Patent Application Publication
(10) Pub. No.: US 2020/0307989 A1
(43) Pub. Date: Oct. 1, 2020

(54) Rope Halter Buckle with Floating Cam-lock Center Bar Washer

(71) Applicant: Vernon Arthur Brekke, Bozeman, MT (US)

(72) Inventor: Vernon Arthur Brekke, Bozeman, MT (US)

(21) Appl. No.: 16/370,302

(22) Filed: Mar. 29, 2019

(51) Int. Cl. B68B 1/02; B68B 5/00

(52) U.S. Cl. CPC B68B 1/02; A44B 11/12; B68B 5/00

(57) ABSTRACT

The essence of this invention is the use of the floating cam-lock washer that replaces the center bar on a typical buckle. The buckle base consists of a plate with a figure-eight hole in the center. The non-looped end of the rope halter is inserted from the underside of the buckle and pulled through to the point of adjustment on the horse. The non-looped end of the rope halter is then inserted and pulled through the cam-lock washer and inserted back through the buckle base to exit on the underside of the buckle. The non-looped end of the rope halter is then pulled tight to the top of the buckle with the washer at a 90 degree position to the base of the buckle. To lock the buckle in place, the washer is rotated 90 degrees to a parallel position with the buckle base. To unlock the buckle, the washer is rotated 90 degrees back to a vertical position—this reduces the pressure of the non-looped end of the rope halter with respect to the buckle base and allows the buckle, on the non-looped end of the rope halter rope, to be easily slid through the base and the floating washer to tighten or loosen the rope halter. The fact that the washer is floating rather than attached makes the adjustment process much easier as the non-looped end of the rope halter does not have to bend through a tight arrangement of fixtures.

This buckle and cam-lock washer combination is also significantly easier to manufacture and less expensive than similar mechanical attachments. The base is a simple plate with a hole cut in it and the washer is a common commercial size and shape. It is the unique relationship between the base and the washer that creates the cam-locking solution to holding the buckle in place and serve as an attachment for the rope halter.

### BACKGROUND OF INVENTION

The present invention relates to an improved buckle for securing the connecting ends of a rope halter for horses. The usual method for connecting the ends of a horse halter has been with a hand-tied knot. One end of the rope halter is pulled over the horses head and neck and then connects through a corresponding loop on the other side of the rope halter. The non-looped rope halter end is then interwoven around and through the loop to form a knot that secures the rope halter to the horses head. The knot must be tied and untied each time the halter is placed on or removed from a horse.

In the past there have been attempts to use a mechanical method to replace the rope halter knot. The only design that is commercially available requires that the rope halter be changed to accommodate the attachment buckle.

### CROSS-REFERENCE TO RELATED APPLICATIONS

CN1128084C 2003 Nov. 19 Bounding system

U.S. Pat. No. 4,977,860A 1990 Dec. 18 Stay assembly for tethering animals

US20040262353A1 2004 Dec. 30 Multi-purpose utility strap and method therefore

U.S. Pat. No. 2,758,858A 1956 Aug. 14 Knot-tying implement

U.S. Pat. No. 4,777,784A 1988 Oct. 18 Horse tethering device

U.S. Pat. No. 5,636,412A 1997 Jun. 10 Fixed circumference binding device with non-protruding free end and method for binding therewith

U.S. Pat. No. 6,606,769B1 2003 Aug. 19 Carabiner for use with strap

U.S. Pat. No. 2,861,547A 1958 Nov. 25 Adjustable leash

U.S. Pat. No. 4,831,692A 1989 May 23 Hook for releasable attaching to at least one end

U.S. Pat. No. 2,826,172A 1958 Mar. 11 Animal actuated restraining dog harness

U.S. Pat. No. 8,001,659B2 2011 Aug. 23 Tensioning device DE112013006025B4 2018 May 9 Wire clamping device

DE10045493A1 2002 Aug. 29 Restraining collar for close control of dog, has combination harness, lead collar, and neck halter with inner band and outer band

U.S. Pat. No. 5,497,733A 1996 Mar. 12 Animal control, training apparatus and method of use

EP2736607B1 2017 Aug. 23 Strap adjuster and keeper and method of strap control

### BRIEF SUMMARY OF INVENTION

The present invention is fundamentally different than any of the previous mechanical inventions. It replaces the hand-tied knot with a new metal connecting plate/buckle and a cam-locking washer that acts as a floating center bar. It will work on a standard rope halter without modification to the rope halter.

The buckle is installed on the non-looped end of the halter rope that is pulled over the horse's head and neck. The buckle can slide up and down the non-looped end of the rope halter to adjust the tightness of the fit on the horse and the cam-locking washer component of the buckle locks the buckle in place so that it will not slide under normal pressure from the horse. Once the buckle is installed on the non-looped end of the horse halter, the rope halter may be connected/attached by pulling the non-looped end of the rope halter, with the buckle installed, through the rope halter loop until the rope halter loop locks on the underside of the buckle. The rope halter will remain connected, with the installed buckle, and resist pressure from the horse against the rope halter. To release the buckle and the non-looped end of the horse halter, simply disengage the rope halter loop from under the buckle and pull the buckle and the non-looped rope back out of the rope halter loop. The rope halter may be attached and reattached multiple times without adjusting the position of the buckle or the cam-lock washer.

### DESCRIPTION OF THE DRAWINGS

In order that this invention may be clearly understood a preferred embodiment of the invention will now be described with reference to the accompanying pictures and drawings:

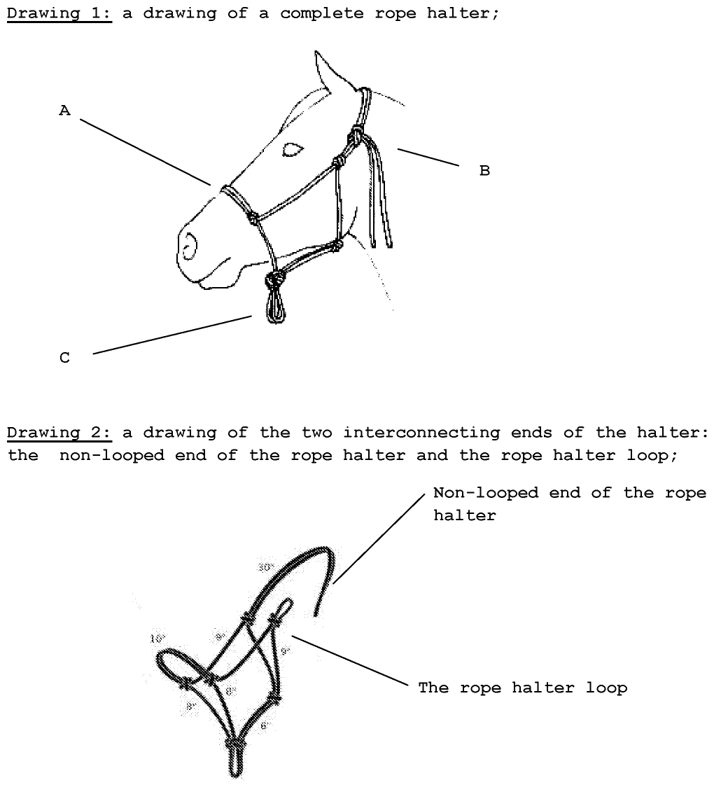

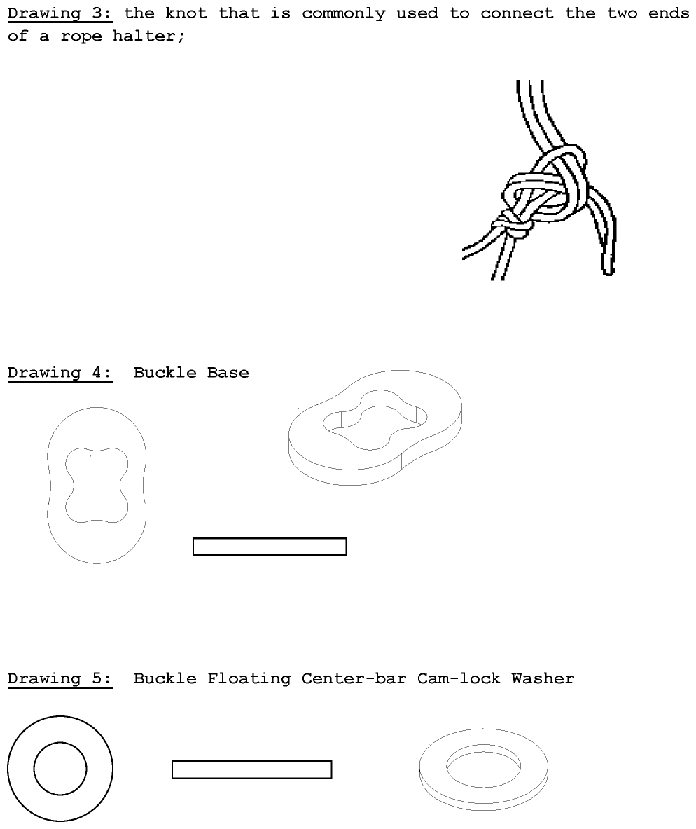

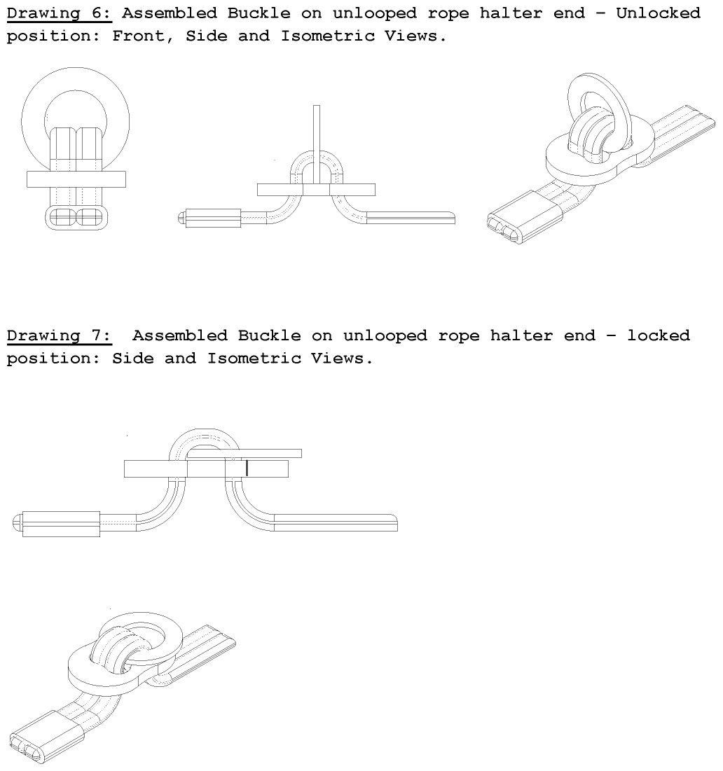

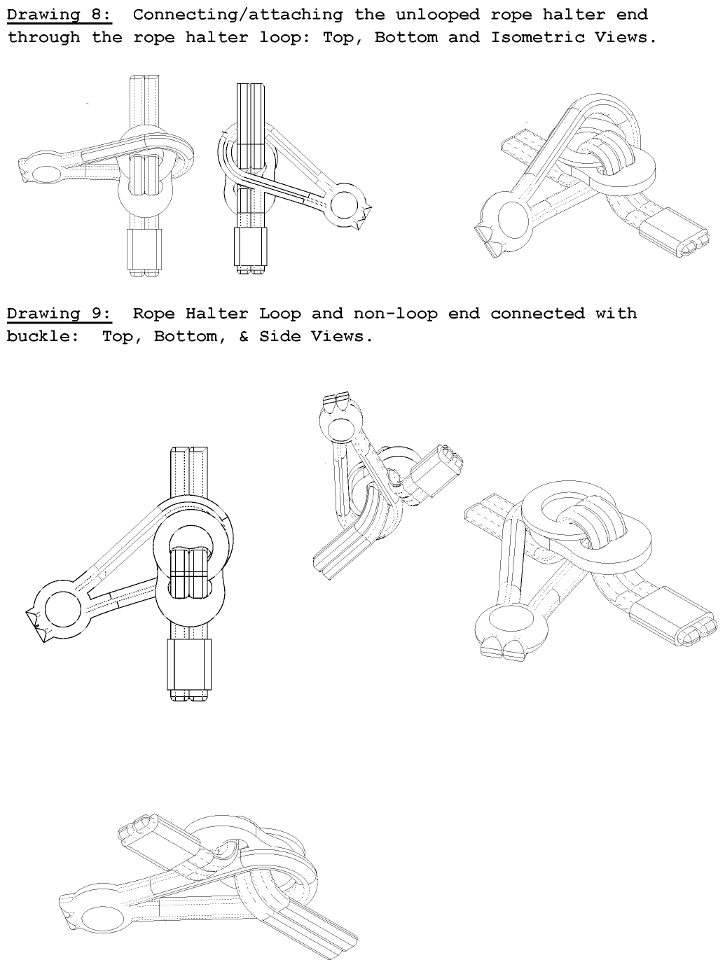

As seen in Drawing 1, a rope halter consists of a rope that is tied in a series of knots in a pattern that is intended to encircle a horse's head in such a way as to allow secure attachment of a lead line or restraining line to the horse. The loop at Drawing 1 “A” is installed around the horse's nose. The two connecting ends of the halter, shown in Drawing 1, are looped around the horse's neck and tied together at Drawing 1 “B”. The lead line or restraining line is attached at FIG. 1 “C”.

Drawing 2 shows the two connecting ends of the halter: the non-looped end of the rope halter and the rope halter loop.

Drawing 3 shows the knot that is commonly used to connect the two rope ends that secure the halter to the horse. In the past, this knot must be tied and untied each time the halter is installed or removed.

The essence of this invention is the use of the floating cam-lock washer. The buckle base, shown in Drawing 4, consists of a plate with a figure-eight hole in the center. The cam-lock washer, shown in Drawing 5, is used in conjunction with the buckle base. The non-looped end of the rope halter, shown in Drawing 2, is inserted from the underside of the buckle and pulled through to the point of adjustment on the horse. The non-looped end of the rope halter is then inserted and pulled through the cam-lock washer, shown in Drawing 6 and inserted back through the buckle base to exit on the underside of the buckle. The non-looped end of the rope halter is then pulled tight to the top of the buckle with the washer at a 90 degree position to the base of the buckle, also shown in Drawing 6. To lock the buckle in place, the washer is rotated 90 degrees (which expands the width of the washer as it is the center bar of the buckle) to a parallel position with the buckle base, shown in Drawing 7. To unlock the buckle, the washer is rotated 90 degrees back to a vertical position, shown in Drawing 6—this reduces the pressure of the non-looped end of the rope halter with respect to the buckle base and allows the buckle, on the non-looped end of the rope halter rope, to be easily slid through the base and the floating washer to tighten or loosen the rope halter. The fact that the washer is floating rather than attached makes the

1. An apparatus for connecting and disconnecting the closed looped end and the unattached straight end of a rope halter, comprising:
1. a base plate that consists of a flat plate of material thick enough to prevent slippage of the base plate on the rope halter with an internal hole of sufficient size and shape to allow the unattached straight rope ends of a rope halter to pass through without obstruction in two directions simultaneously and an external size small enough to pass through the standard sized rope halter closed looped end but large enough to have adequate overhang in relation to the internal hole to restrict the retraction of the base plate from the rope halter loop after the base plate has been pulled through the rope halter loop and with the material strength to resist the dynamic pressure of a large animal on the rope halter without bending or breaking,
2. a washer that consists of a single piece of circular material with an interior hole that is also circular in shape of adequate size to allow the unattached straight ends of a rope halter to pass through without obstruction with sufficient distance between the interior hole and the exterior rim of the washer to act as a cam to lock the buckle to the rope halter when rotated to a position parallel to the top face of the base plate with the material strength to resist the dynamic pressure of a large animal on the rope halter without bending or breaking,
3. a relationship between the base plate of claim 1 and the washer of claim 2 and the unattached straight end of the rope halter that is completed when the base plate of claim 1 is connected to the washer of claim 2 by the unattached straight end of the rope halter when the unattached straight end of the rope halter is pushed up through the interior hole of the base plate then through the interior hole of the washer and back down through the interior hole of the base plate and the rope is tightened to hold the washer tightly against the base plate; the closed looped end and the unattached straight end of a rope halter are then connected by passing the unattached straight end of the rope halter with the attached buckle through the closed looped end of the rope halter until the buckle latches on the closed looped end of the rope halter; the closed looped end and the unattached straight end of a rope halter are disconnected by passing the unattached straight end of the rope halter with the attached buckle back through the closed looped end of the rope halter until the unattached straight end of the rope halter with the attached buckle are disconnected from the closed looped end of the rope halter.
